(19) United States
(12) Patent Application Publication
(10) Pub. No.: US 2017/0370308 A1
(43) Pub. Date: Dec. 28, 2017

(54) DYNAMIC SKIP FIRE OPERATION OF A GASOLINE COMPRESSION IGNITION ENGINE

(71) Applicants: Tula Technology, Inc., San Jose, CA (US); Delphi Technologies Inc., Troy, MI (US)

(72) Inventors: Siamak HASHEMI, Farrmington Hills, MI (US); Matthew A. YOUNKINS, San Jose, CA (US); John E. KIRWAN, Troy, MI (US)

(21) Appl. No.: 15/282,308

(22) Filed: Sep. 30, 2016

Related U.S. Application Data
(60) Provisional application No. 62/353,772, filed on Jun. 23, 2016.

(51) Int. Cl. F02D 41/00; F02D 13/06; F02D 41/30; F02B 33/00; F02D 41/14; F02B 37/00

(52) U.S. Cl. CPC F02D 41/0087; F02D 41/1446; F02B 37/00; F02D 41/3035; F02B 33/00; F02D 13/06; F02D 2041/3052; F02D 2200/08

(57) ABSTRACT

A gasoline compression ignition engine is operated in two modes. In a one mode of operation the engine is operated with a firing fraction of one, corresponding to all of the cylinders being active, working cylinders. In a second skip fire mode of operation a firing fraction of less than one may be used under conditions, such as a low load condition, to improve efficiency. The skip fire mode of operation may also be selected in part based on other considerations, such as maintaining an exhaust temperature conducive for efficient catalytic converter operation or limiting cylinder output variability.

### CROSS-REFERENCE TO RELATED APPLICATIONS

This application claims priority of U.S. Provisional Application No. 62/353,772, filed on Jun. 23, 2016, which is incorporated herein by reference in its entirety.

### FIELD OF THE INVENTION

The present invention is generally related to gasoline compression ignition engines. More particularly, an embodiment of the present invention is related to operating a gasoline compression ignition engine in a skip fire manner.

### BACKGROUND OF THE INVENTION

A gasoline compression ignition (GCI) engine (also sometimes known as gasoline direct injection compression ignition (GDCI)) is a type of engine that provides potential improvements in fuel economy. Background information on GCI engines are described in a series of publications by the Delphi Corporation, including the following papers and patent publications, each of which are hereby incorporated by reference:
“Part-Load Operation of Gasoline Direct-Injection Compression Ignition (GDCI Engine),” by Sellnau et al. SAE International (2013);
“Boost System Development for Gasoline Direct Injection Compression Ignition (GDC),” by Hoyer et al., SAE International (2013);
“Development of Full-Time Gasoline Direct-Injection Compression-Ignition (GDCI) for High Efficiency and low CO₂, NOₓ, and PM,” by Sellnau et al., Aachen Colloquium Automobile and Engine Technology (2011);
“GDCI Multi-Cylinder Engine for High Fuel Efficiency and Low Emissions,” by Sellnau et al., SAE International (2015);
“Full-Time Gasoline Direct-Injection Compression Ignition (GDCI) for High Efficiency and Low NOₓ and PM” by Sellnau et al., SAE International (2012);
“Development of a Gasoline Direct Injection Compression Ignition (GDCI) Engine,” by Sellnau et al., SAE International (2014);
“Cold Start Strategy and System For Gasoline Direct Injection Compression Ignition Engine” US Patent Publication 2015/0114339;
“High-Efficiency Internal Combustion Engine and Method For Operating Employing Full-Time Low-Temperature Partially-Premixed Compression Ignition with Low Emissions,” US Patent Publication 2013/0213349.

GCI engines have some general similarities with diesel engines, in that there is a compression of a charge, air, and fuel. However, there are significant differences in the operation of a GCI engine compared with a diesel engine. There are also some general similarities and significant differences with respect to a homogeneous charge compression ignition (HCCI) engine. An HCCI engine is prone to misfires and diesel like noise due to difficulties in controlling the combustion event.

In a GCI engine, the air in the cylinder is initially compressed to high pressure and temperature. The fuel is injected late, sometimes even after top dead center (TDC) into a piston bowl devised in the piston top. The late injection inhibits the fuel getting into the crevice volume and provides high combustion efficiency with low emissions. The mixture in the GCI is intentionally stratified, unlike an HCCI engine. Multi-injection in a GCI engine increases efficiency. It allows stratification of charge in the cylinder that keeps the combustion temperature low, which reduces NOₓ emissions and minimizes heat transfer through the cylinder wall, improving efficiency.

However, GCI engines have problems operating efficiently at low engine load requirements. At low engine loads, thermodynamics are less favorable and parasitic losses have a higher contribution to reducing overall efficiency. Variable valve lift technology improves GCI combustion performance at lower loads, however this introduces additional cost and complexity to a GCI engine, and still does not provide efficiencies available at higher loads.

### SUMMARY OF THE INVENTION

Embodiments of the present invention include an apparatus, system, and method to operate a gasoline compression ignition (GCI) engine in skip fire manner. The skip fire operation may be utilized in a low engine load regime to improve fuel efficiency. In one embodiment, skip fire operation may also be based on an emission control condition, such as an exhaust gas consideration. The firing fraction may be dynamically selected based on monitored engine conditions to achieve a desired engine output.

### BRIEF DESCRIPTION OF THE DRAWINGS

FIG. 1 illustrates a skip fire controller for a gasoline compression ignition engine in accordance with an embodiment.

FIG. 2 illustrates a firing fraction module in accordance with an embodiment.

FIG. 3 illustrates load considerations in selecting a firing fraction for a gasoline compression engine.

FIG. 4 illustrates a method of selecting a firing fraction for a gasoline compression engine in accordance with an embodiment.

### DETAILED DESCRIPTION

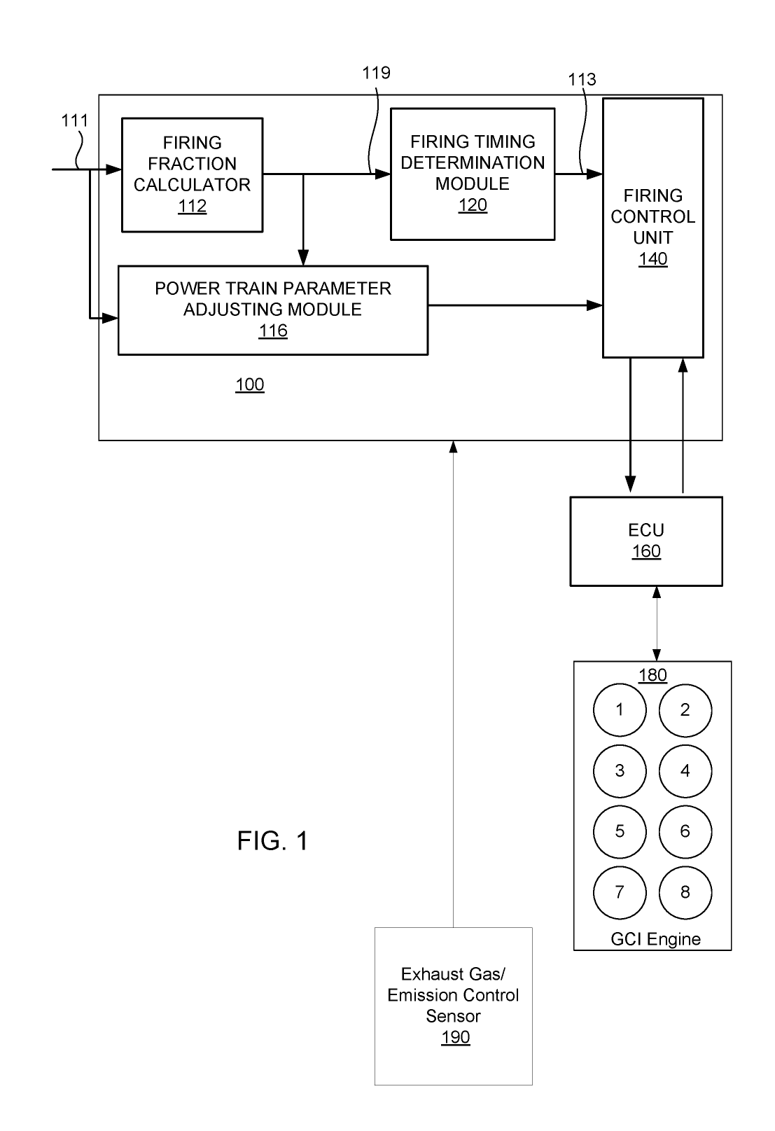

Referring initially to FIG. 1, a skip fire powertrain controller 100 according to a particular embodiment of the present invention will be described. The skip fire powertrain controller 100 monitors engine conditions and automatically makes decisions which cylinders of a gasoline compression ignition (GCI) engine 180 are active (e.g., which cylinders are active working cylinders that receive fuel versus which cylinders are deactivated and do not receive fuel and/or otherwise not working cylinders). The skip fire powertrain controller 100 supports a conventional mode of operation in which all of the cylinders of the GCI engine are working cylinders (a firing fraction of one). However, the skip fire powertrain controller 100 also supports a dynamic skip fire (DSF) mode in which only a fraction of the cylinders are activated (a firing fraction of less than one, e.g., ½, ¾, etc). Background information on dynamic skip fire technology is described in U.S. Pat. Nos. 7,954,474; 7,886,715; 7,849,835; 7,577,511; 8,099,224; 8,131,445; 8,131,447; 9,086,020; 8,616,181 and 8,701,628, the contents of which are hereby incorporated by reference.

The skip fire powertrain controller 100 may be incorporated as part of a larger engine control unit (ECU) 160. However, for the purposes of illustration the skip fire powertrain control 100 is illustrated as a separate unit.

In one embodiment, the skip fire powertrain controller 100 includes a firing fraction calculator 112, a firing timing determination module 120, a powertrain parameter adjustment module 116, and a firing control unit 140. The firing fraction calculator 112 and the firing timing determination module 120 coordinate their operations to determine a suitable operational firing fraction and skip fire firing sequence for a gasoline compression ignition (GCI) engine 180 having a plurality of cylinders (e.g., 4, 6, or 8 cylinders). The skip fire powertrain controller 100 may be implemented using dedicated electronics hardware, firmware, or as microprocessor controller with an associated memory.

The firing fraction calculator 112 receives a torque request signal 111 based on the current accelerator pedal position, engine speed and other inputs. The torque request signal 111, which indicates a request for a desired engine output, may be received or derived from an accelerator pedal position sensor or other suitable sources, such as a cruise controller, a torque calculator, an engine control unit (ECU), etc.

Based on the torque request signal 111, the firing fraction calculator 112 determines a skip fire firing fraction that would be appropriate to deliver the desired torque under selected engine operations. The engine operating conditions are determined by the power train parameter adjusting module 116. Adjusted parameters may include, but are not limited to, mass air flow, absolute intake manifold pressure, throttle position, cam phasing, cam lift, and exhaust gas recirculation. Each firing fraction 112 is indicative of the fraction or percentage of firings under the current (or directed) operating conditions that are required to deliver the desired output. In some preferred embodiments, the firing fraction may be determined based on the percentage of optimized firings that are required to deliver the driver requested engine torque (e.g., when the cylinders are firing at an operating point substantially optimized for fuel efficiency). However, in other instances, different level reference firings, firings optimized for factors other than fuel efficiency, the current engine settings, etc. may be used in determining the firing fraction. In various embodiments, the firing fraction is selected from a set or library of predetermined firing fractions.

The firing fraction determination process may take into account a variety of factors, including noise, vibration, and harshness (NVH), fuel efficiency, and the desired torque. In some situations, for example, there is a particular firing fraction that delivers a desired torque in the most fuel efficient manner, given the current engine speed (e.g., using optimized firings.) If that firing fraction is available for use by the firing fraction calculator and also is associated with acceptable NVH levels, the firing fraction calculator 112 selects that firing fraction and transmits it to the firing timing determination module 120, so that a suitable operational firing sequence can be generated based on the firing fraction.

The firing fraction calculator 112 is arranged to store and/or access data to help it make the above determinations and energy efficiency comparisons. Any suitable data structure or algorithm may be used to make the determinations. In some embodiments, for example, the firing fraction calculator 112 uses a lookup table to determine a suitable operational firing fraction. In still other embodiments, the firing fraction calculator makes such determinations by dynamically calculating and comparing the energy efficiency associated with different candidate firing fractions and/or sequences. Some of these approaches will be described in greater detail later in the application.

After selecting a suitable operational firing fraction, the firing fraction calculator 112 transmits the firing fraction 119 to the firing timing determination module 120. The firing timing determination module 120 is arranged to issue a sequence of firing commands (e.g., drive pulse signal 113) that cause the GCI engine 180 to deliver the percentage of firings dictated by a commanded firing fraction 119. In some implementations, for example, the firing timing determination module 120 generates a bit stream, in which each 0 indicates a skip and each 1 indicates a fire for the current cylinder firing opportunity. The GCI engine 180 may use cam activated intake and exhaust valves. The intake valves allow the cylinders to induct air and in some cases fuel from an intake manifold. The exhaust valves allow the cylinders to vent exhaust gases to an exhaust system. The intake and exhaust valves may be deactivated on a firing-opportunity by firing-opportunity basis by inhibiting opening of at least one valve during a skipped working cycle.

The firing timing determining module 120 may generate the firing sequence in a wide variety of ways. By way of example, sigma delta convertors work well as the firing timing determining module 120. In still other embodiments, the firing timing determination module selects a suitable firing sequence from a firing sequence library based on the received firing fraction. The firing fraction decisions may be made on a frequent basis. By way of example, the firing fraction may be updated on a cycle-by-cycle basis (e.g., at every possible firing opportunity).

In a GCI engine there are a range of operating conditions in which activating all of the cylinders in a conventional firing sequence (with a firing fraction of one) results in non-optimum conditions. This generally occurs in a low-load situation. In a GCI engine, the air in the cylinder is first compressed and the fuel is injected late. The heat caused by compression triggers combustion. At low engine loads, thermodynamics are less favorable so that the overall fuel efficiency is reduced compared to operation at higher loads.

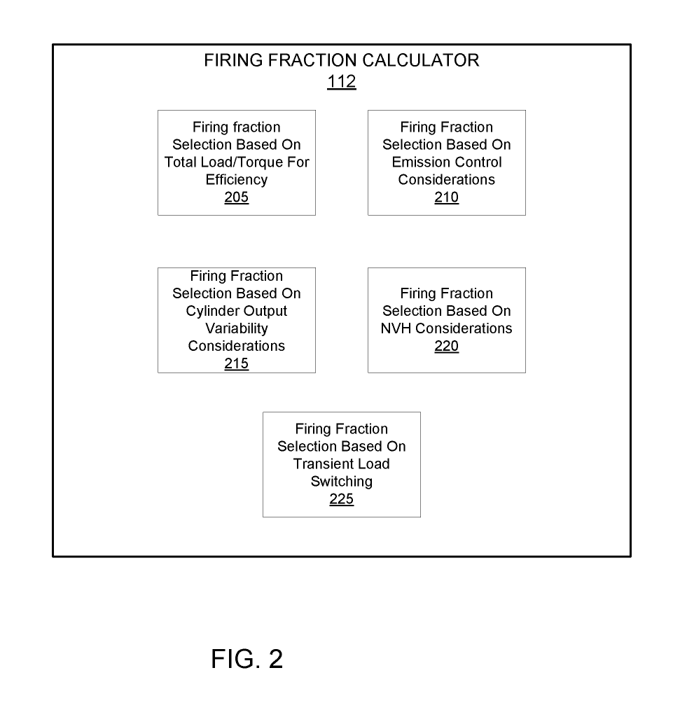

FIG. 2 illustrates an embodiment of the firing fraction calculator 112. In one embodiment, the firing fraction calculator includes a module 205 to support making a firing fraction selection based at least in part on the desired engine output and which firing fraction(s) are the most efficient 205 given the nature of combustion in a GCI engine. This may include, for example, a lookup table to determine a suitable operational firing fraction. In still other embodiments, module 205 makes a dynamic calculation and compares the energy efficiency associated with different candidate firing fractions and/or sequences. In some embodiments, a module 210 may be provided to select a firing fraction to support adjusting a temperature of an exhaust gas based on emission control considerations. For example, after a cold start, the firing fraction may be initially selected to be less than one to increase the exhaust gas temperature. For example, if the exhaust gas is below a selected threshold, an adjustment to the firing fraction may be determined. Module 210 may, for example, also be implemented as a lookup table or use a dynamic calculation. A module 215 may also be included to select dynamically a firing fraction based on cylinder firing variability considerations. The firing fraction selection may include consideration of parameters indicative of combustion stability, such as the coefficient of variation (COV) in the indicated mean effective pressure (IMEP) or some other measure of a fired cylinder's output. Large variations in cylinder output may be indicative that the cylinder is operating near the limit of combustion stability where misfires may occur. Operation in such regions should be minimized or avoided all together. A module 225 may also be included to manage firing fraction during engine transients. The firing fraction may be dynamically selected to manage air flow and exhaust gas recirculation (EGR) concentration desired by the engine during the load switching transients. A module 220 may also be included to select dynamically a firing fraction based on NVH considerations. U.S. Pat. No. 9,086,020 and pending U.S. patent application Ser. Nos. 13/963,686 and 14/638,908, which are herein incorporated by reference, describe modules that select a firing fraction based at least in part on NVH considerations. It will be understood that the above considerations may be used in combination in making a firing fraction selection.

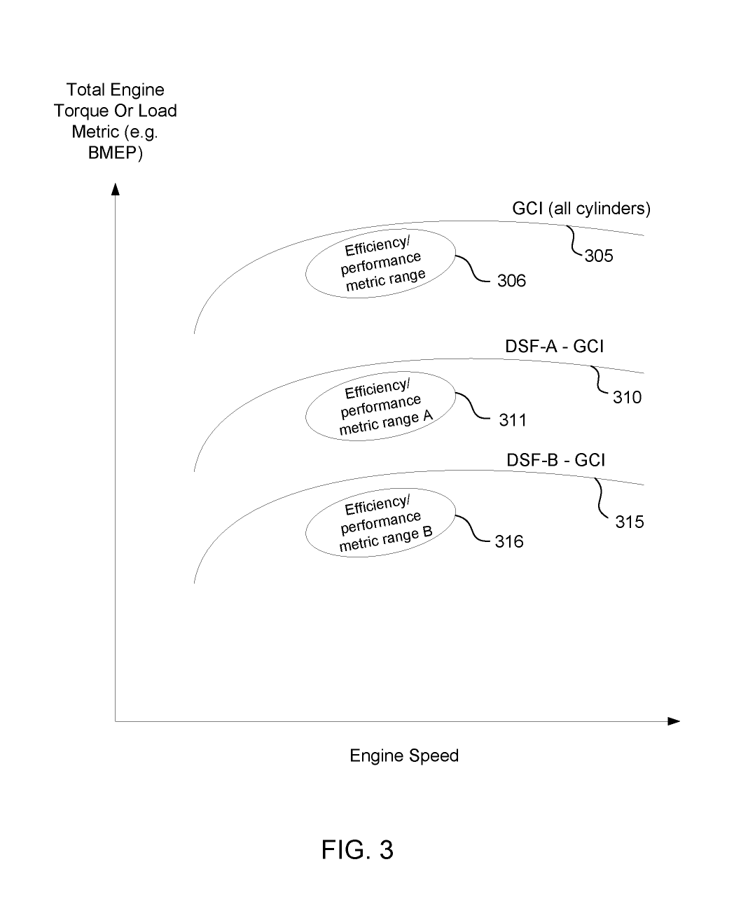

FIG. 3 illustrates, at a high level, a simplification of some general considerations for skip fire operation of a GCI engine. There are several different ways to model the performance of a GCI engine in different load regimes. These include, for example, plotting a brake mean effective pressure (BMEP) against engine speed and also considering regions (contours) having an efficiency metric, such as a brake specific fuel consumption (BSFC), which is the fuel consumption divided by a measurement of power. At low load conditions, a GCI engine with a firing fraction of one will tend to have a worse measure of metrics such as BSFC. One option is to thus select a skip fire mode based on an efficiency metric, such as BSFC. Thus the firing fraction may be selected based on an efficiency consideration. For a given firing fraction there will be ranges of load and engine speed having a given range of fuel efficiency. In the general case, this results in a complex set of load/engine-speed/efficiency contours for a given firing fraction. However, a given firing fraction will tend to provide high efficiency over a range of loads and engine speeds.

Operating curve 305 represents the maximum engine output as a function of engine speed that a GCI engine with a firing fraction of one (i.e. all cylinder operation) can produce. Under normal driving conditions the maximum engine output is seldom required, so the engine typically operates somewhere below curve 305. Beneath maximum engine output curve 305 there is a range of load and engine speed conditions that have high efficiency operation. This range is denoted by encircled area 306. If the engine load is below area 306, i.e. a low load condition, it will not be operating in an efficient region. By reducing the firing fraction below one, the high efficiency operating region can be shifted to overlap lower load conditions.

Curve 310 illustrates the maximum engine load versus engine speed for a first firing fraction “A” less than one. This curve is similar to curve 305, but displaced toward lower overall engine loads. The high efficiency operating region associated with this firing fraction is denoted as 311. Similarly, curve 315 illustrates the maximum engine load versus engine speed for a second firing fraction “B”, lower than the first firing fraction “A”. The high efficiency operating region associated with firing fraction “B” is denoted as 316. In all the high efficiency operating regions, 306, 311, and 316 the active, firing cylinders are operating under similar conditions, which are optimal or near-optimal for GCI operation. By operating the engine in a skip fire mode, with a firing fraction less than one, the active cylinder load can thus remain high even under low load conditions. For clarity the curves 305, 310, and 315 and their associated high efficiency performance range, 306, 311, and 316 are shown as widely separated. In practice, there may be many possible operating curves corresponding to different firing fractions and their high efficiency performance ranges may overlap with each other.

For a specific GCI engine design, experimental studies or theoretical modeling may be used to determine specific ranges of loads (e.g., BMEP) and engine speed and corresponding efficiency metrics (e.g., BSFC) for different firing fractions. This information, in turn, would be used to determine one or more firing fractions satisfying an efficiency condition for a given range of load and engine speed. Additionally, the most efficient firing fraction for a particular load/engine-speed range may be determined, as well as the efficiency of nearby firing fractions. This information may, for example, be summarized in lookup tables or used to generate a model to determine an optimum firing fraction for a given set of load and engine speed conditions.

In the example of FIG. 3, DSF technology permits the cylinder load to be controlled by selecting the firing fraction to fire fewer cylinders when there is a low overall engine power requirement (e.g., low total load). This allows for active cylinders to be operated within an optimum load range (for efficient combustion) even when the total engine power requirement drops. DSF allows for cylinder deactivation to reduce the overall engine power by using just enough cylinders (within an optimum load range per active cylinder above some minimum level for efficient combustion) to achieve the total engine power demand. For example, the firing fraction may be selected to achieve at least a minimum load in active cylinders required to achieve thermodynamic conditions necessary to sustain stable combustion.

In a more general case, a range of possible firing fractions is supported and DSF is used to dynamically select a firing fraction in response to changes in engine power requirements. This, in turn, permits an improvement in fuel efficiency at low load conditions by running a reduced number of cylinders at higher load per active cylinder while the non-firing cylinders act as air springs. In this regime (e.g., curves 310 and 315), the high cylinder load per active cylinder means the active cylinder will be compressed with a normal range of compression that achieves temperatures necessary to sustain stable and efficient combustion.

In addition to other considerations, the firing fraction may be selected based on the temperature of the exhaust gas and aspects of an emission control system. Selecting a lower firing fraction (for a given engine load/power requirement) results in higher exhaust gas temperatures. For example, in one embedment, the firing fraction is also selected to control an exhaust gas temperature. As an example, the firing fraction may be selected based on a catalytic converter consideration, such as a “catalyst light off control” condition. As an illustrative example, it may be desirable, in terms of the performance of an emissions control system, to select a lower firing fraction of the GCI engine after a cold start, in order to rapidly increase the exhaust gas temperature after a cold start. Thus, referring back to FIG. 1, in one embodiment, an exhaust gas temperature or other emissions control signal of a sensor 190 may be used as an additional factor in considering a firing fraction. As an illustrative example, the sensor 190 may detect the exhaust gas temperature at an inlet of a catalytic converter. In turbocharged engines the sensor 190 may measure a turbo inlet temperature. The exhaust gas temperature may be adjusted to provide optimal or near optimal temperatures at the turbocharger inlet for best boost conditions. However, more generally other emission control signals could be used as an additional consideration in selecting a firing fraction. Moreover, the exhaust gas temperature under warmed-up conditions may be selected to ensure high efficiency of the emission control system to reduce regulated emissions from the tailpipe.

The firing fraction may also be dynamically selected to adapt to variability in cylinder output either from cycle to cycle or across all of the engine's cylinders. Cylinder output variability (e.g, COV-IMEP or other measure of cylinder output variability) is also an important consideration in optimizing engine operation. In one embodiment, the cylinder output variability is another consideration in dynamically selecting a firing fraction. The firing fraction decisions may be made frequently, such as on a cycle-by-cycle basis and over the range of possible firing fractions. Thus when there is a low load, the firing fraction selection may also be implemented to optimize COV-IMEP at low engine loads of the GCI engine. Thus, in addition to other considerations, the dynamic selection of the firing fraction may be selected to adapt to cylinder output variability.

The firing fraction may also be dynamically selected to manage air flow and exhaust gas recirculation (EGR) concentration desired by the engine during load transients. The load in a given cylinder with GCI combustion can result in substantial differences in air flow and EGR desired for optimized combustion. Changing the fraction of cylinders fired in response to changes in desired engine torque and power allows for less variation in desired air flow and EGR, which can result in improved fuel economy, reduced emissions, and better driveability.

When the firing fraction is less than one, the non-firing cylinders can operate in a spring mode, where both the intake and exhaust valves are closed and gas is trapped within the cylinder. A variety of spring modes are possible for a deactivated cylinder based on the opening and closing timing of the intake and exhaust valves and other parameters. These include a low pressure spring mode where either air or a fraction of the combustion exhaust gases from a preceding combustion event are trapped in the cylinder or a high pressure spring mode where substantially all the exhaust gases are trapped in the cylinder. Alternatively, a cylinder may be deactivated by only closing one set of either the intake or exhaust valves, in which case no spring is formed in a deactivated cylinder.

In one embodiment, when the firing fraction is less than one, the non-firing cylinders have at least two pressure modes, including a high pressure spring mode and a low pressure spring mode. In this embodiment, the spring pressure mode may be further selected to adjust an engine torque. Thus, in addition to firing fraction, the spring mode of non-firing cylinders may also be selected to provide additional control.

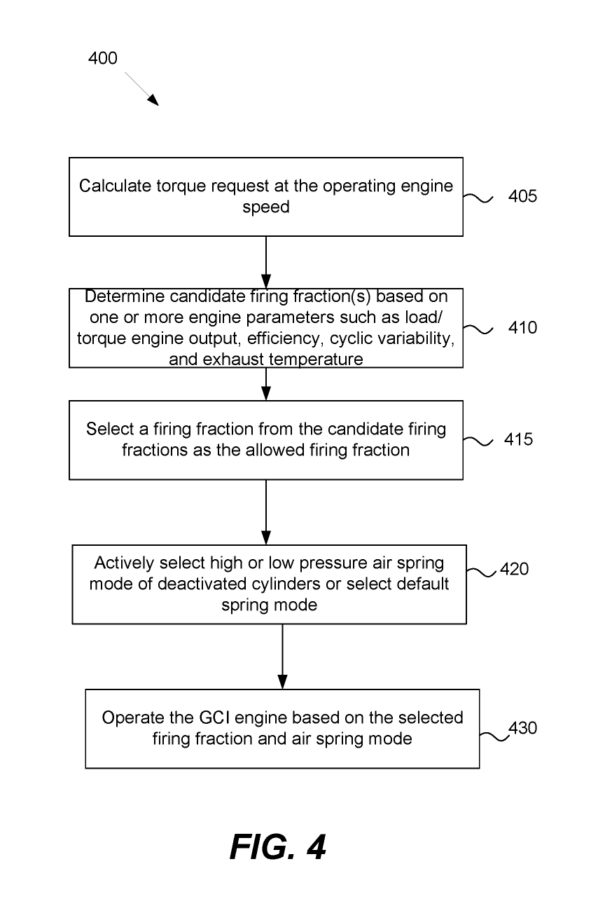

FIG. 4 is a flow chart of a method 400 in accordance with an embodiment. The torque is calculated at the engine speed 405. Candidate firing fractions are determined 410 based on one or more engine parameters such as the desired engine output (e.g., load/torque), efficiency, cylinder output variability, and exhaust temperature. A firing fraction is selected from the candidate firing fractions as the allowed firing fraction 415. This may include, for example, accessing lookup tables or performing dynamic calculation to determine firing fractions capable of satisfying the load requirement, comparing efficiency, and also considering other criteria, such as NVH or cylinder output variability, in making a selection of a firing fraction. A selection may be performed 420 of an air spring mode or a high or low pressure exhaust spring mode for deactivated cylinders. The GCI engine is then operated 430 at the selected firing fraction.

In one embodiment, operating the GCI engine in a skip fire manner eliminates the requirement of variable valve lift technology for low load conditions, thus reducing complexity and cost. In another embodiment, the GCI engine in a skip fire manner may improve/enable some diagnostic (such as on-board-diagnostics (OBD)) modes like catalyst monitoring or cylinder balancing.

The invention has been described in conjunction with specific embodiments, it will be understood that it is not intended to limit the invention to the described embodiments. On the contrary, it is intended to cover alternatives, modifications, and equivalents as may be included within the spirit and scope of the invention as defined by the appended claims. The present invention may be practiced without some or all of these specific details. In addition, well known features may not have been described in detail to avoid unnecessarily obscuring the invention. In accordance with the present invention, the components, process steps, and/or data structures may be implemented using various types of operating systems, programming languages, computing platforms, computer programs, and/or computing devices. In addition, those of ordinary skill in the art will recognize that devices such as hardwired devices, field programmable gate arrays (FPGAs), application specific integrated circuits (ASICs), or the like, may also be used without departing from the scope and spirit of the inventive concepts disclosed herein. The present invention may also be tangibly embodied as a set of computer instructions stored on a computer readable medium, such as a memory device.

1. A method of operating a gasoline compression ignition engine having a plurality of cylinders, comprising:
selecting a firing fraction of the gasoline compression ignition engine for a desired engine output; and
operating the gasoline compression engine in a skip fire manner according to the selected firing fraction, wherein the selected firing fraction determines a fraction of cylinders that are active and fired with the remaining cylinders being skipped such that the skipped cylinders are deactivated,
wherein the firing fraction is at least partially selected to achieve at least a minimum load in active cylinders.

2. (canceled)

3. The method of claim 1, wherein the minimum load corresponds to at least a minimum load required to achieve thermodynamic conditions necessary to sustain stable combustion.

4. The method of claim 1, wherein the gasoline compression engine is operated in a skip fire manner to improve fuel economy.

5. The method of claim 1, wherein the firing fraction is selected to control cylinder load at a desired engine output.

6. The method of claim 1, wherein the firing fraction is selected based at least in part on an exhaust temperature of exhaust gases received by an emission control system.

7. The method of claim 6, wherein the exhaust temperature under warmed-up engine conditions is selected to ensure high efficiency of the emission control system to reduce regulated emissions from the tailpipe.

8. The method of claim 6, wherein the firing fraction after a cold start of the engine is selected based on a catalyst light off control condition.

9. The method of claim 1, wherein the firing fraction is selected based at least in part on cylinder output variability.

10. The method of claim 1, wherein the firing fraction is adjusted dynamically during engine load transients.

11. The method of claim 1, wherein the non-firing cylinders act as air springs.

12. The method of claim 11, wherein the non-firing cylinders have at least two pressure modes, including a high pressure mode and a low pressure mode, and the pressure mode is selected to adjust an engine torque.

13. A skip fire engine controller for a gasoline compression ignition engine having a plurality of cylinders, comprising:
a skip firing fraction module arranged to determine an operational firing fraction and associated engine settings to deliver a desired engine output for the gasoline compression ignition (GCI) engine; and
a firing timing controller arranged to direct firings in a skip fire manner that delivers the selected operational firing fraction,
wherein the skip fire engine controller is arranged to select the firing fraction to achieve at least a minimum load in active cylinders.

14. (canceled)

15. The skip fire engine controller of claim 13, wherein the minimum load corresponds to at least a minimum load required to achieve a temperature necessary to sustain stable combustion.

16. The skip fire engine controller of claim 13, wherein the skip fire engine controller is arranged to operate the gasoline compression engine in a skip fire manner to improve fuel economy.

17. The skip fire engine controller of claim 13, wherein the skip fire engine controller is arranged to select the firing fraction to control cylinder load at a desired engine output.

18. The skip fire engine controller of claim 13, wherein the skip fire engine controller is arranged to select the firing fraction based at least in part on an exhaust temperature of exhaust gases received by an emission control system.

19. The method of claim 18, wherein the exhaust temperature under warmed-up engine conditions is selected to ensure high efficiency of the emission control system to reduce regulated emissions from the tailpipe.

20. The skip fire engine controller of claim 18, wherein the skip fire engine controller is arranged to select the firing fraction after a cold start of the engine based on a catalyst light off control condition.

21. The skip fire engine controller of claim 13, wherein the skip fire engine controller selects the firing fraction based at least in part on cylinder output variability.

22. The skip fire engine controller of claim 13, wherein the skip fire engine controller dynamically adjusts the firing fraction during engine load transients.

23. The skip fire engine controller of claim 13, wherein non-firing cylinders act as air springs.

24. The skip fire engine controller of claim 13, wherein the non-firing cylinders have at least two pressure modes, including a high pressure mode and a low pressure mode, and the pressure mode is selected to adjust an engine torque.

25. The skip fire engine controller of claim 13, wherein the skip fire engine controller is used on a GCI engine using at least one of a turbocharger or a supercharger to boost air pressure in an intake manifold.

26. The skip fire engine controller of claim 25, wherein the skip fire engine controller is arranged to select the firing fraction based at least in part on an exhaust temperature or pressure of exhaust gases required to optimize at least one of the turbocharger and the supercharger operation.

27. An engine system, comprising:
a gasoline compression ignition engine; and
a skip fire engine controller arranged to select a firing fraction of the gasoline compression ignition engine to achieve a desired engine output,
wherein the firing fraction is at least partially selected to achieve at least a minimum load in active cylinders of the gasoline compression engine.
